(19) United States
(12) Patent Application Publication
(10) Pub. No.: US 2004/0187740 A1
(43) Pub. Date: Sep. 30, 2004

(54) Cementitious composition

(75) Inventor: Scott F. Timmons, San Antonio, TX (US)

Correspondence Address: PAULA D. MORRIS & ASSOCIATES, P.C., d/b/a THE MORRIS LAW FIRM, P.C., 10260 WESTHEIMER, SUITE 360, HOUSTON, TX, 77042-3110, US

(73) Assignee: Research Incubator, Ltd., Corpus Christi, TX (US)

(21) Appl. No.: 10/716,241

(22) Filed: Nov. 18, 2003

Related U.S. Application Data
(60) Provisional application No. 60/457,992, filed on Mar. 27, 2003.
(60) Provisional application No. 60/508,726, filed on Oct. 3, 2003.

(51) Int. Cl. C04B 14/00; C04B 18/06

(52) U.S. Cl. 106/705; 106/706; 106/801; 106/708; 106/811; 106/813; 106/789; 106/672; 106/675; 106/676; 106/679; 106/681

(57) ABSTRACT

Cementitious compositions comprising pozzolonic materials, alkaline earth metals, and a catalysts to catalyze the reaction between the pozzolonic materials and the alkaline earth metals.

### CROSS-REFERENCE TO RELATED APPLICATIONS

The present application claims the benefit of the filing date of U.S. Provisional Patent Application Serial No. 60/457,992, filed Mar. 27, 2003, and U.S. Provisional Patent Application Serial No. 60/508,726, filed Oct. 3, 2003.

### FIELD OF THE INVENTION

The present invention relates to the use of catalysts in cementitious compositions.

### BACKGROUND OF THE INVENTION

Pozzolans can be used in combination with Ordinary Portland Cement (“OPC”) to produce products of superior strength and chemical resistance when used at levels up to about 3:1 OPC to pozzolan. At replacement levels of roughly 25% of the OPC, pozzolans conforming to ASTM C-618 can achieve, in 28 days, at least 75% of the strength obtained in an identical mix without pozzolan. Most often, the strength at 28 days is lower than the strength of the OPC without pozzolan, however, strength gains after 28 days surpass the strength obtained with OPC alone. The slow rate of strength gain limits the practical amount of OPC replacement with pozzolan to about 25% or less.

Pozzolan accelerators based on alkali metals have been used. These alkali accelerators maintain a high pH and provide soluble alkali-metals required for pozzolonic acceleration. Using these accelerators, OPC replacement by pozzolan can be as much as 90%, depending upon the application. Common accelerators include alkali silicates, carbonates and hydroxides. An unfortunate feature common to alkali-metal based pozzolan accelerators, and other currently available accelerators, is their caustic nature. Caustic accelerators can cause contact bums and present significant safety risks.

Pozzolan accelerators are needed that maintain high levels of OPC replacement while providing a safe, stable alternative to caustic accelerators.

### BRIEF DESCRIPTION OF THE DRAWINGS

FIG. 1 depicts the strength curve of high pozzolan concrete with catalyst.

FIG. 2 depicts the effects of the water-reducing component in Example 6, on the water requirements necessary to achieve a flowable consistency with fly ash.

### SUMMARY OF THE INVENTION

A cementitious composition comprising a first amount of a pozzolonic material; a second amount of a compound comprising an alkaline earth metal; and a catalyst selected from the group consisting of an alkali-containing zeolite, an alkali-containing feldspathoid, and combinations thereof. The catalyst being adapted to catalyze the pozzolonic reaction between the alkaline earth metal and the pozzolonic material. The first and second amounts being effective, upon addition of sufficient water, to produce a product cement.

### DETAILED DESCRIPTION OF THE INVENTION

The present invention provides a cementitious composition useful for accelerating the reaction between pozzolonic materials and alkaline earth metals. The cementitious composition includes (a) a “pozzolonic material” (defined below), (b) an “alkaline earth metal” (defined below), and (c) a “zeolite” or “feldspathoid” catalyst (defined below). In addition to accelerating the reaction between the pozzolonic materials and alkaline earth metals, the zeolite or feldspathoid catalyst (1) allows for higher concentrations of pozzolonic material to replace the alkaline earth metal in the composition, (2) allows for superior rates of strength gain over prior art compositions, and (3) provides a non-caustic alternative to the pozzolan accelerators generally known and used in the art.

All of the above ingredients can be interground or interblended and used as a complete cementitious composition with or without additional admixtures. In addition to the properties already recited, compositions formed in accordance with the present invention are durable, have superior freeze-thaw resistance without the use of air-entraining admixtures, have superior sulfate and sulfuric acid resistance, excellent resistance to abrasion and are more impermeable to moisture and chloride than other concretes and mortars.

In general, the term “cementitious” refers to materials including those typically required to make cement. Generally speaking, cementitious materials are binder materials that harden to form a connecting medium between solids. Cementitious materials include cements, which may include any mixture of finely-ground lime, alumina, and silica that will set to a hard product that combines with other ingredients to form hydrates, including but not necessarily limited to OPC, hydraulic cements, blended cement, and masonry cement, mortar, and related aggregate, admixtures and/or additives including hydrated lime, limestone, chalk, calcareous shell, talc, slag or clay. In a preferred embodiment, the term “cementitious” refers to the total amount of OPC plus pozzolonic material and catalyst.

(a)—Pozzolonic Material

The cementitious composition comprises a pozzolonic material. Pozzolonic materials are inorganic materials, either naturally occurring or industrial by-products typically comprising siliceous compounds or siliceous and aluminous compounds. Examples of suitable pozzolonic materials include, but are not necessarily limited to one or a combination of commercially available pozzolans including coal fly ash, silica fume, diatomaceous earth, calcined or uncalcined diatomite, calcined fullers earth, pozzolonic clays, calcined or uncalcined volcanic ash, bagasse ash, rice hull ash, natural and synthetic zeolites, metakaolin, slag and other sources of amorphous silica. Examples of suitable fly ash include, but are not necessarily limited to, Type F, Type C or Type N as defined in ASTM C-618, “Specification for Coal Fly ash and Raw or Calcined Natural Pozzolan for Use as a Mineral Admixture in Portland Cement Concrete.” Preferred pozzolonic materials may be obtained from the following commercial sources: Boral Material Technologies; ISG, and LaFarge.

Suitably, the cementitious composition is composed of from about 10% to 95% by weight pozzolonic material, preferably from about 40% to about 95% by weight pozzolonic material. In a preferred embodiment, the pozzolonic material makes up approximately 80% of the total weight of the composition, depending on the application. Suitable pozzolonic materials comprise from about 10% to about 50% by weight amorphous silica or vitreous silica (hereafter “silica”), preferably from about 20% to about 40% by weight silica, even more preferably about 35% silica.

(b)—Alkaline Earth Metal

The cementitious composition comprises an alkaline earth metal. The alkaline earth metals include but are not necessarily limited to: calcium, magnesium, beryllium, strontium, and barium. Preferred alkaline earth metals are calcium and magnesium. In a preferred embodiment, the cementitious composition comprises a “calcium-containing material” including, but not necessarily limited CaO and Ca(OH)₂ effective to react with the pozzolonic material. Examples of suitable calcium-containing materials include, but are not necessarily limited to one or a mixture of OPC, calcium aluminate cement, calcium sulfoaluminate cement, hydrated lime, quicklime and lime kiln dust. In a preferred embodiment, OPC including all types of OPC (I-V and IA-IIIA) as referenced in ASTM C 150-95 may be used. Of course, the particular calcium-containing material used will depend, in the poorest areas of the world, on the most readily available, inexpensive option. Preferred calcium-containing materials may be obtained from the following commercial sources: Texas Industries, Inc.; California Portland Cement Co.; and North Texas Cement Company; Cemex; and Alamo Cement.

OPC is essentially a mixture of hydraulic calcium silicates and calcium aluminum silicates contained in a crystalline mass. Major compounds include tricalcium silicate, dicalcium silicate, tricalcium aluminate, tetracalcium aluminoferrite, calcium sulfate dihydrate (Gypsum). A suitable composition includes from about 5% to about 90% by weight of OPC. A preferred composition includes from about 5% to about 20% by weight of OPC, most preferably about 10% by weight of OPC.

(c)—Catalyst

The cementitious composition also comprises a catalyst. Suitable catalysts are pozzolan accelerators. Examples of suitable catalysts include, but are not necessarily limited to “alkali exchanging aluminosilicates.” In a preferred embodiment, the catalysts include alkali-containing zeolites comprising one or more alkali metal(s) and alkali-containing feldspathoids comprising one or more alkali metal(s) that function as the source of alkali necessary to catalyze the reaction between the pozzolonic material and alkaline earth metal (i.e., react pozzolonically with calcium to release the alkali).

Zeolites are crystalline, hydrated aluminosilicates. Suitable zeolites may be either naturally-occurring or synthetic in origin. Preferred naturally-occurring zeolites include, but are not necessarily limited to one or a mixture of analcime, chabazite, gmelinite, mordenite, natrolite, faujasite, phillipsite, sodalite, nepheline, scapolite, cancrinite, erionite and clinoptilolite. Preferred synthetic zeolites include, but are not necessarily limited to one or a mixture of a Type A, Type X, SYNTHETIC CLINOPTILOLITE, Type B, Type F, Type K-F, Type G, Type P-B, Type P-C, Type Z, Type ZK-19, Type ZSM-2 and Type ZSM-3.

Feldspathoids are similar in chemical composition and structure to zeolites and have open cavities within the aluminosilicate structure capable of containing alkali metals. As such, feldspathoids are similar to zeolites in that they are pozzolonic and have exchangeable alkali ions. Preferred examples of feldspathoids include, but are not necessarily limited to nepheline (NaAlSiO₄ with a little potassium) and leucite (KAlSi₂O₆). Preferred catalysts may be obtained from the following commercial sources: PQ Corporation; and Zeolyst International.

Compositionally, zeolites are similar to clay minerals. Zeolites differ, however, in their crystalline structure. Whereas many clays have a layered crystalline structure (similar to a deck of cards) and are subject to shrinking and swelling as water is absorbed and removed between the layers, zeolites have a rigid, 3-dimensional crystalline structure (similar to a honeycomb) consisting of a network of interconnected tunnels and cages. Water moves freely in and out of these pores but the zeolite framework remains rigid. Another special aspect of this structure is that the pore and channel sizes are nearly uniform, allowing the crystal to act as a molecular sieve. The porous zeolite is host to water molecules and ions of potassium and calcium, as well as a variety of other positively charged ions, but only those of appropriate molecular size to fit into the pores are admitted creating the “sieving” property. Zeolites of a preferred embodiment contain sodium ions.

In general, pozzolonic materials alone possess little or no cementitious value. In the presence of moisture, pozzolonic materials react with calcium hydroxide to form compounds possessing cementitious properties including calcium silicate hydrates, calcium aluminate hydrates and calcium silicoaluminate hydrates. In a preferred embodiment, the amount of zeolite or feldspathoid in the composition is not substantial enough to be responsible for the accelerating effect by itself without additional pozzolan. Thus, the action of the zeolite or feldspathoid must be that it is catalyzing the pozzolonic reaction between the calcium-containing material (OPC, for example) and the pozzolonic material (fly ash, for example). “Pozzolanic activity,” refers to the ability of the silica and alumina components of fly ash and the like to react with available calcium and/or magnesium from the hydration products of OPC. ASTM C618 requires that the pozzolanic activity index with OPC, as determined in accordance with ASTM C311, be a minimum of 75 percent of the average 28-day compressive strength of control mixes made with OPC. The optimum amount of zeolite or feldspathoid necessary to catalyze the reaction is dependent upon the reactive nature of the pozzolonic material and can be determined by producing test articles containing varying amounts of the zeolite or feldspathoid. For example, when a Type F fly ash is used as a pozzolonic material, it is preferred to use from about 0.1% to about 10% by weight zeolite in the cementitious composition, preferably from about 2% to about 4% by weight zeolite in the cementitious composition for optimum results. When a Type C fly ash is used as a pozzolonic material, it is preferred to use from about 0.1% to about 10% by weight zeolite in the cementitious composition, preferably from about 0.5% to about 1.5% by weight zeolite in the cementitious composition. Where less rapid setting is desired, the percentage of catalyst can be reduced. Where more rapid setting is desired, the percentage of catalyst can be increased.

Preferred zeolites or feldspathoids comprise particles having an average diameter of from about 0.1 microns to about 10 microns, preferably from about 2 microns to about 7 microns, most preferably about 5 microns. The average diameter can be obtained by grinding or pulverizing larger particles or by separating means. In a preferred embodiment, the zeolites or feldspathoids comprise pores having an average diameter of from about 2 Å to about 8 Å, preferably from about 3 521 to about 5 Å, most preferably about 4.2 Å.

Water, of course, is mixed with the composition in the amount required to process the composition for the use sought (i.e. workable consistency), after the dry ingredients discussed above have all been thoroughly admixed. The amount of water used in the composition depends on the ultimate use of the composition (i.e., floor or wall, or building products such as cinder block, etc.). The particular amount of water necessary for any given composition may be determined by routine experimentation.

In addition to the main components, other components may be added for particular purposes. For example, expanded fillers can be added to form lightweight cinder blocks and tile. Examples of expanded fillers include, but are not necessarily limited to hollow glass cenospheres, glass or polymer microspheres, vermiculite, expanded pearlite, expanded polystyrene, expanded shale or clay, or synthetic lightweight aggregate. The amount of expanded filler added can vary widely depending upon the density and strength desired in the final product.

The use of additional components may also be employed to (1) further accelerate the very early strength (1 to 3-day strength) of the cementitious composition, (2) reduce the water requirements (using a water-reducing component), and (3) modify the viscosity (i.e., viscoelastic properties) of the cementitious composition (using a viscosity modifier). Each of these components may be added to a particular composition in an amount sufficient to produce acceptable qualities for a particular application.

Typical early strength enhancers include, but are not necessarily limited to calcium salts such as calcium chloride, calcium nitrate, calcium lactate, calcium formate and calcium bromide. Other non-calcium early strength enhancers include, but are not necessarily limited to thiosulfates, thiocyanates, amines (especially triethanolamine), glyoxal, urea, formaldehyde and aluminates such as sodium aluminate or aluminum trihydroxide.

Herein, a water-reducing component refers to a chemical admixture that allows for the production of a cementitious composition at a given workable consistency while using less water. The amount of water-reducing component used will vary depending upon the particular cementitious composition. A preferred amount of water-reducing component is an amount necessary to decrease the water requirement of the admixture by about 10% or more, while still achieving a workable consistency of the cementitious composition. For example, the test indicated in Example 6 shows the effect upon viscosity of the cementitious composition (i.e., cement paste) using a water-reducing component/fly ash ratio in amounts ranging from 0.005 to 0.025. By inspection, the water requirement of the cement compositions using the water-reducing component decreased by about 20%. Water-reducing components include, but are not necessarily limited to calcium or alkali salts of sulfonated lignin (such as DARACEM-19® and DARACEM-100®) hydroxylated polymers and copolymers, salts of hydroxy carboxylic acids (expecially sodium citrate and sodium gluconate), salts of condensation polymers of melamine urea and melamine formaldehyde, salts of condensation polymers of sulfonated naphthalene formaldehyde (such as BOREM B-600 CNL, BOREM 100-HNL, BOREM 100-HSP), formaldehyde/urea polymers, carboxylated polyethers (such as ADVA FLOW®), and sulfonated condensation copolymers of formaldehyde and ketones.

When using high-range water-reducing admixtures, segregation is often encountered. Viscosity modifiers are added to reduce, preferably to prevent segregation. Herein segregation is defined as the settlement of aggregrate from the viscoelastic paste due to viscosity thinning of the paste. Modifications to the viscoelastic properties are accomplished using viscosity modifying admixtures, also referred to as viscosity enhancing agents. Suitable viscosity modifiers include, but are not necessarily limited to hydroxyethyl cellulose, guar gum, carageenan gum, various clays, salts of acrylic acid and acrylic acid copolymers, acrylamide polymers and copolymers of acrylamide. In addition, all of the above mentioned ingredients, including water-reducing components alone, or in combination with viscosity modifiers, may further be used in the manufacture of self consolidating concrete (SCC).

The cementitious composition reacts and sets rapidly to produce a product cement. The compression strength of the product cement is comparable to the compression strength of other cements. Without limiting the invention to a particular mechanism of action, it is believed that zeolites and feldspathoids accelerate the pozzolonic reaction by serving as the source of alkali.

Depending on the type and amount of catalyst used, the pH of the pozzolonic reaction is from about 10 to about 14, preferably from about 11 to about 14, most preferably about 12. Another factor used to determine the amount of catalyst used in a given cementitious composition is the desire to control or prevent efflorescence, the amount of air-entraining agents used, and the amount of the chemical and solid components used.

When mixed with water, the cementitous composition is easily extruded, compression molded, or cast into simple or complex shapes. Suitable compression strengths are achieved in about 3 days to about 56 days, preferably in about 7 days to about 28 days, most preferably in about 28 days. The higher the temperature and the relative humidity, the more rapid the attainment of higher compressive strengths. It is preferred during manufacture to operate at the highest temperature practical, up to about 130° F., depending on the location of operation.

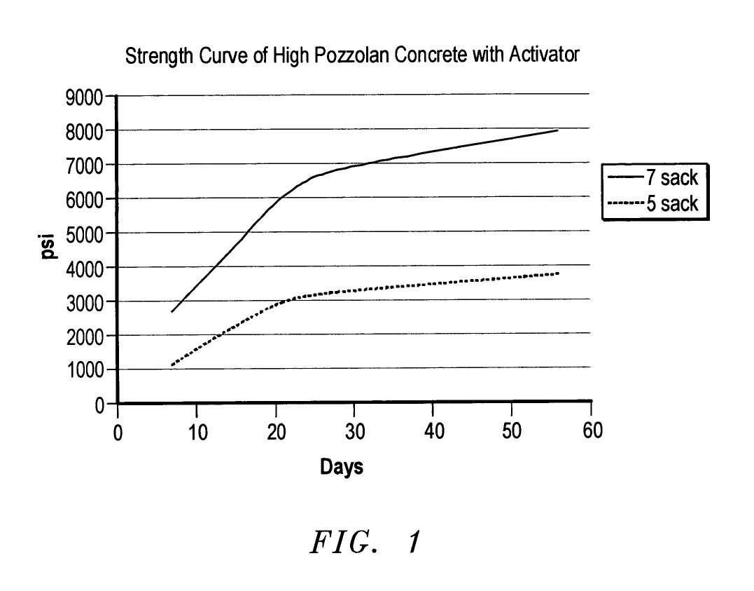

Typical strength curves for 7 and 5 sack mixes of the present composition are shown in FIG. 1. The term “sack” refers to the number of cubic feet of cementitious material used. As can be seen, strengths approaching 7000 psi are possible in 28 days in a recipe containing 7 cu ft. of cement per yard of concrete. As demonstrated, 7 cu ft. of cement weighs 490 lbs and contains 389 lbs of Type C fly ash and 95 lb of Type I OPC. The strength curve is obtained without the use of water reducing admixtures or any other admixtures except zeolite or feldspathoid. The strength of similar recipes without the catalyst can be up to about 80% less strong at 28 days as the recipes that contain them. In other words, the strength of the cement product at 28 days is greater than the strength of the same cement product in the absence of said catalysts selected from the group consisting of zeolite, feldspathoid, and a combination thereof.

All components of the cementitous composition can be mixed using either a batch mixer or a continuous mixer (i.e., mobile truck mixer). Proper mixing considerations include for instance: location of the construction site (distance to a ready-mix plant), the amount of product needed, the construction schedule (volume of product needed per hour), the cost of the mixing method, and the quality of the mixture desired (i.e. distributing all the components uniformly).

The invention will be better understood with reference to the following examples, which are illustrative only and not intended to limit the present invention to a particular embodiment.

### EXAMPLE 1

High Strength F Ash/Concrete Block Fill/Mortar Recipe.

| Material | Amount |
|---|---|
| Type C-33 concrete Sand | 735 g. |
| Type I Portland Cement | 60 g. |
| Type F Fly Ash (Limestone Plant) | 200 g. |
| Valfor 100 Zeolite | 7 g. |
| Lime | 3 g. |
| B-100 Water Reducer | 1.5 g. |
| Water | 75.5 mL |

All dry ingredients were dry mixed before water was added. The water was added and the mixture was molded into 2″×2″ cubes. The mixture was a free flowing, self-leveling material and required minimal finishing. The strength at 24 hours was 776 psi, the 9-day strength was 3983 psi. and the strength at 29 days was 5465 psi.

### EXAMPLE 2

High Strength C Ash/Concrete Recipe

| Material | Amount |
|---|---|
| Type C Fly Ash (Parish, TX Plant) | 430 lbs |
| Type I Portland Cement | 115 lbs |
| Type C-33 silica Sand | 1620 lbs |
| 1.5″ crushed limestone aggregate | 1700 lbs |
| ADVERA 401 Zeolite | 14.7 lbs |
| Water | 200 lbs (estimate) |

The solid ingredients were mixed using a mobile mix concrete truck. The fly ash (700 lb.), cement (188 lb.) and zeolite (24 lb) were dry mixed using a portable mortar mixer and then transferred to the cement silo of the mobile mix truck. The truck was calibrated to deliver 8 cubic feet of the above cement mixture (density of 70 lb/cu ft.), 1620 lb of sand and 1700 lb of rock per yard of concrete produced and sufficient water to produce a 3″ slump (estimated at 200 lb). The concrete thus produced exhibited strengths of 4360 psi at 14 days, 6020 psi at 21 days, 6810 psi at 28 days and 7933 psi at 56 days. No water reducers or additional admixtures were used.

### EXAMPLE 3

Normal Strength C-Ash/Concrete Recipe

| Material | Amount |
|---|---|
| Type C Fly Ash (Parish, TX Plant) | 284 lbs |
| Type I Portland Cement | 69 lbs |
| Type C-33 silica Sand | 1830 lbs |
| 1.5″ crushed limestone aggregate | 1700 lbs |
| ADVERA 401 Zeolite | 3.75 lbs |
| Water | 125 lbs (estimate) |

The solid ingredients were mixed using a mobile mix concrete truck. The fly ash (910 lb.), cement (220 lb.) and zeolite (12 lb) were dry mixed using a portable mortar mixer and then transferred to the cement silo of the mobile mix truck. less catalyst was used to prevent the occurrence of efflorescence. The truck was calibrated to deliver 5 cubic feet of the above cement mixture (density of 70 lb/cu ft.), 1830 lb of sand and 1700 lb of rock per yard of concrete produced and sufficient water to produce a 3″ slump (estimated at 125 lb). The concrete thus produced exhibited strengths of 1130 psi at 7 days, 2130 psi at 14 days and 3230 psi at 28 days. No additional admixtures or water reducers were used.

### EXAMPLE 4

Shotcrete Recipe

| Material | Amount |
|---|---|
| Type C Fly Ash (Parish, TX Plant) | 426 lbs |
| Type I Portland Cement | 103 lbs |
| Silica Sand | 2280 lbs |
| 3/8″ gravel | 1520 lbs |
| ADVERA 401 Zeolite | 5.63 lbs |
| Water | 190 lbs (estimate) |

The solid ingredients were mixed using a mobile mix concrete truck. The fly ash (910 lb.), cement (220 lb.) and zeolite (12 lb) were dry mixed using a portable mortar mixer and then transferred to the cement silo of the mobile mix truck. Less catalyst was used to prevent the occurrence of efflorescence. The truck was calibrated to deliver 7.5 cubic feet of the above cement mixture (density of 70 lb/cu ft.), 2280 lb of sand and 1520 lb of pea gravel per yard of concrete produced and sufficient water to produce a 1″ to 2″ slump (estimated at 190 lb). The concrete thus produced exhibited strengths of 980 psi at 4 days and 4760 psi at 28 days. No additional admixtures or water reducers were used.

### EXAMPLE 5

Acid Resistant Concrete Recipe

| Material | Amount |
|---|---|
| Type C Fly Ash (Martin Lake, TX | 988 grams |
| Plant) | |
| Type I Portland Cement | 156 grams |
| Silica Sand | 2280 grams |
| 3/8″ gravel | 1924 grams |
| ADVERA 401 Zeolite | 24.36 grams |
| Sulfonated Copolymer of | 12.1 grams |
| Formaldehyde and Ketone | |
| Water | 141 grams |

The solid ingredients were combined in a mixer. Once mixed, water was added and the ingredients were further mixed for 90 seconds and then packed into several 3″×6″ plastic molds. Each molded article was cured at 130° F. for 15 hours, then removed from the mold. The strength of the material at 24 hours was 3,490 psi. The strength of the material at 28 days it was 6,090 psi.

### EXAMPLE 6

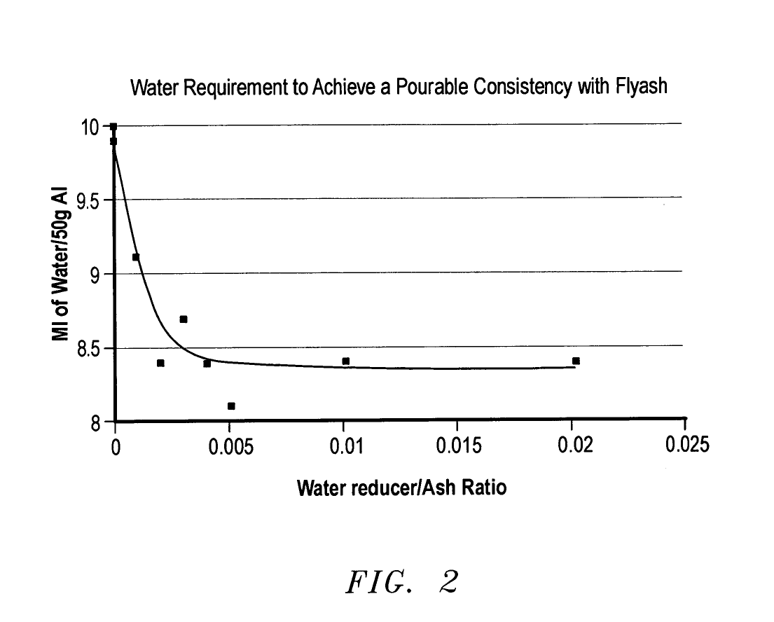

To determine the optimum levels of water-reducing component, the following test was performed. 50 g of fly ash and varying amounts of sulfonated formaldehyde and ketone (water-reducing component) were mixed together and a sufficient amount of water was added to each mixture to achieve flowable consistency. FIG. 2 depicts the effects of the water-reducing component on the water requirements necessary to achieve a flowable consistency with fly ash.

Persons of ordinary skill in the art will recognize that many modifications may be made without departing from the spirit and scope of the invention defined by the claims. The embodiment(s) described herein are meant to be illustrative only and should not be taken as limiting the invention, which is defined in the claims.

I claim:

1. A cementitious composition comprising:
a first amount of a pozzolonic material;
a second amount of a compound comprising an alkaline earth metal; and
a catalyst selected from the group consisting of an alkali-containing zeolite, an alkali-containing feldspathoid, and combinations thereof, the catalyst being adapted to catalyze the pozzolonic reaction between the alkaline earth metal and the pozzolonic material;
said first amount and said second amount being effective, upon addition of sufficient water and curing, to produce an effective cement product.

2. The cementitious composition of claim 1 wherein the pozzolonic material is selected from the group consisting of fly ash, silica fume, diatomaceous earth, calcined or uncalcined diatomite, calcined fullers earth, pozzolonic clays, calcined or uncalcined volcanic ash, bagasse ash, rice hull ash, natural and synthetic zeolites, metakaolin, and slag.

3. The cementitious composition of claim 1 wherein said first amount is from about 10% to about 95% by weight of said cementitious composition.

4. The cementitious composition of claim 1 wherein said first amount is from about 40% to about 95% by weight pozzolonic material.

5. The cementitious composition of claim 1 wherein said first amount is about 80% by weight pozzolonic material.

6. The cementitious composition of claim 2 wherein said first amount is from about 10% to about 95% by weight pozzolonic material.

7. The cementitious composition of claim 2 wherein said first amount is from about 40% to about 95% by weight pozzolonic material.

8. The cementitious composition of claim 2 wherein said first amount is about 80% by weight pozzolonic material.

9. The cementitious composition of claim 5 wherein said first amount is from about 10% to about 50% by weight amorphous silica.

10. The cementitious composition of claim 5 wherein said first amount is from about 20% to about 40% by weight amorphous silica.

11. The cementitious composition of claim 5 wherein said pozzolonic material comprises about 35% by weight amorphous silica.

12. The cementitious composition of claim 8 wherein said pozzolonic material comprises from about 10% to about 50% by weight amorphous silica.

13. The cementitious composition of claim 8 wherein said pozzolonic material comprises from about 20% to about 40% by weight amorphous silica.

14. The cementitious composition of claim 8 wherein said pozzolonic material comprises about 35% by weight amorphous silica.

15. The cementitious composition of claim 2 further comprising Type F fly ash.

16. The cementitious composition of claim 15 wherein said catalyst comprises from about 0.1% to about 10% by weight zeolite.

17. The cementitious composition of claim 15 wherein said catalyst comprises from about 2% to about 4% by weight zeolite.

18. The cementitious composition of claim 2 further comprising Type C fly ash.

19. The cementitious composition of claim 18 wherein said catalyst comprises from about 0.1% to about 10% by weight zeolite.

20. The cementitious composition of claim 18 wherein said catalyst comprises from about 0.5% to about 1.5% by weight zeolite.

21. The cementitious composition of claim 1 wherein said zeolite comprises particles having an average diameter of from about 0.1 microns to about 10 microns.

22. The cementitious composition of claim 1 wherein said zeolite comprises particles having an average diameter of from about 2 microns to about 7 microns.

23. The cementitious composition of claim 1 wherein said zeolite comprises particles having an average diameter of about 5 microns.

24. The cementitious composition of claim 1 wherein said zeolite comprises pores having an average diameter of from about 2 Å to about 8 Å.

25. The cementitious composition of claim 1 wherein said zeolite comprises pores having an average diameter of from about 3 Å to about 5 Å.

26. The cementitious composition of claim 1 wherein said zeolite comprises pores having an average diameter of about 4.2 Å.

27. The cementitious composition of claim 1 wherein the alkaline earth metal is selected from the group consisting of calcium and magnesium.

28. The cementitious composition of claim 2 wherein the alkaline earth metal is selected from the group consisting of calcium and magnesium.

29. The cementitious composition of claim 1 wherein the alkaline earth metal comprises a calcium-containing material selected from the group consisting of CaO and Ca(OH)₂, said calcium-containing material being effective to react with the pozzolonic material.

30. The cementitious composition of claim 2 wherein the alkaline earth metal comprises a calcium-containing material selected from the group consisting of CaO and Ca(OH)₂, said calcium-containing material being effective to react with the pozzolonic material.

31. The cementitious composition of claim 27 wherein the alkaline earth metal comprises a calcium-containing material selected from the group consisting of CaO and Ca(OH)₂, said calcium-containing material being effective to react with the pozzolonic material.

32. The cementitious composition of claim 28 wherein the alkaline earth metal comprises a calcium-containing material selected from the group consisting of CaO and Ca(OH)₂, said calcium-containing material being effective to react with the pozzolonic material.

33. The cementitious composition of claim 31 wherein the calcium-containing material is selected from the group consisting of ordinary Portland cement, calcium aluminate cement, calcium sulfoaluminate cement, hydrated lime, quicklime, lime kiln dust, and combinations thereof.

34. The cementitious composition of claim 32 wherein the calcium-containing material is selected from the group consisting of ordinary Portland cement, calcium aluminate cement, calcium sulfoaluminate cement, hydrated lime, quicklime, lime kiln dust, and combinations thereof.

35. The cementitious composition of claim 33 wherein said alkaline earth metal comprises from about 5% to about 90% by weight OPC.

36. The cementitious composition of claim 33 wherein said alkaline earth metal comprises from about 5% to about 20% by weight OPC.

37. The cementitious composition of claim 33 wherein said alkaline earth metal comprises about 10% by weight OPC.

38. The cementitious composition of claim 34 wherein said alkaline earth metal comprises from about 5% to about 90% by weight OPC.

39. The cementitious composition of claim 34 wherein said alkaline earth metal comprises from about 5% to about 20% by weight OPC.

40. The cementitious composition of claim 34 wherein said alkaline earth metal comprises about 10% by weight OPC.

41. The cementitious composition of claim 1 wherein the catalyst is a naturally-occurring zeolite selected from the group consisting of analcime, chabazite, gmelinite, mordenite, natrolite, faujasite, phillipsite, sodalite, nepheline, scapolite, cancrinite, erionite, clinoptilolite, and combinations thereof.

42. The cementitious composition of claim 2 wherein the catalyst is a naturally-occurring zeolite selected from the group consisting of analcime, chabazite, gmelinite, mordenite, natrolite, faujasite, phillipsite, sodalite, nepheline, scapolite, cancrinite, erionite, clinoptilolite, and combinations thereof.

43. The cementitious composition of claim 31 wherein the catalyst is a naturally-occurring zeolite selected from the group consisting of analcime, chabazite, gmelinite, mordenite, natrolite, faujasite, phillipsite, sodalite, nepheline, scapolite, cancrinite, erionite, clinoptilolite, and combinations thereof.

44. The cementitious composition of claim 32 wherein the catalyst is a naturally-occurring zeolite selected from the group consisting of analcime, chabazite, gmelinite, mordenite, natrolite, faujasite, phillipsite, sodalite, nepheline, scapolite, cancrinite, erionite, clinoptilolite, and combinations thereof.

45. The cementitious composition of claim 42 wherein the catalyst is a naturally-occurring zeolite selected from the group consisting of analcime, chabazite, gmelinite, mordenite, natrolite, faujasite, phillipsite, sodalite, nepheline, scapolite, cancrinite, erionite, clinoptilolite, and combinations thereof.

46. The cementitious composition of claim 44 wherein the catalyst is one or more synthetic zeolite selected from the group consisting of a Type A, Type X, synthetic clinoptilolite, Type B, Type F, Type K-F, Type G, Type P-B, Type P-C, Type Z, Type ZK-19, Type ZSM-2, Type ZSM-3, and combinations thereof.

47. The cementitious composition of claim 45 wherein the catalyst is one or more synthetic zeolite selected from the group consisting of a Type A, Type X, synthetic clinoptilolite, Type B, Type F, Type K-F, Type G, Type P-B, Type P-C, Type Z, Type ZK-19, Type ZSM-2, Type ZSM-3, and combinations thereof.

48. The cementitious composition of claim 1 further comprising an expanded filler selected from the group consisting essentially of hollow glass cenospheres, glass or polymer microspheres, vermiculite, expanded pearlite, expanded polystyrene, expanded shale or clay, synthetic lightweight aggregate, and combinations thereof.

49. The cementitious composition of claim 2 further comprising an expanded filler selected from the group consisting essentially of hollow glass cenospheres, glass or polymer microspheres, vermiculite, expanded pearlite, expanded polystyrene, expanded shale or clay, synthetic lightweight aggregate, and combinations thereof.

50. The cementitious composition of claim 31 further comprising an expanded filler selected from the group consisting essentially of hollow glass cenospheres, glass or polymer microspheres, vermiculite, expanded pearlite, expanded polystyrene, expanded shale or clay, synthetic lightweight aggregate, and combinations thereof.

51. The cementitious composition of claim 32 further comprising an expanded filler selected from the group consisting essentially of hollow glass cenospheres, glass or polymer microspheres, vermiculite, expanded pearlite, expanded polystyrene, expanded shale or clay, synthetic lightweight aggregate, and combinations thereof.

52. The cementitious composition of claim 45 further comprising an expanded filler selected from the group consisting essentially of hollow glass cenospheres, glass or polymer microspheres, vermiculite, expanded pearlite, expanded polystyrene, expanded shale or clay, synthetic lightweight aggregate, and combinations thereof.

53. The cementitious composition of claim 1 further comprising a third amount of a water-reducing component effective to decrease by about 10% or more the amount of water that must be added to said cementitious composition to achieve a workable consistency.

54. The cementitious composition of claim 2 further comprising a third amount of a water-reducing component effective to decrease by about 10% or more the amount of water that must be added to said cementitious composition to achieve a workable consistency.

55. The cementitious composition of claim 50 further comprising a third amount of a water-reducing component effective to decrease by about 10% or more the amount of water that must be added to said cementitious composition to achieve a workable consistency.

56. The cementitious composition of claim 51 further comprising a third amount of a water-reducing component effective to decrease by about 10% or more the amount of water that must be added to said cementitious composition to achieve a workable consistency.

57. The cementitious composition of claim 52 further comprising a third amount of a water-reducing component effective to decrease by about 10% or more the amount of water that must be added to said cementitious composition to achieve a workable consistency.

58. The cementitious composition of claim 53 wherein the water-reducing component is selected from the group consisting of calcium or alkali salts of sulfonated lignin, hydroxylated polymers and copolymers, salts of hydroxy carboxylic acids, salts of condensation polymers of melamine urea and melamine formaldehyde, salts of condensation polymers of sulfonated naphthalene formaldehyde, formaldehyde/urea polymers, carboxylated polyethers, sulfonated condensation copolymers of formaldehyde and ketones, and combinations thereof.

59. The cementitious composition of claim 58 wherein said water-reducing component is selected from the group consisting of sodium citrate and sodium gluconate.

60. The cementitious composition of claim 54 wherein the water-reducing component is selected from the group consisting of calcium or alkali salts of sulfonated lignin, hydroxylated polymers and copolymers, salts of hydroxy carboxylic acids, salts of condensation polymers of melamine urea and melamine formaldehyde, salts of condensation polymers of sulfonated naphthalene formaldehyde, formaldehyde/urea polymers, carboxylated polyethers, sulfonated condensation copolymers of formaldehyde and ketones, and combinations thereof.

61. The cementitious composition of claim 55 wherein the water-reducing component is selected from the group consisting of calcium or alkali salts of sulfonated lignin, hydroxylated polymers and copolymers, salts of hydroxy carboxylic acids, salts of condensation polymers of melamine urea and melamine formaldehyde, salts of condensation polymers of sulfonated naphthalene formaldehyde, formaldehyde/urea polymers, carboxylated polyethers, sulfonated condensation copolymers of formaldehyde and ketones, and combinations thereof.

62. The cementitious composition of claim 56 wherein the water-reducing component is selected from the group consisting of calcium or alkali salts of sulfonated lignin, hydroxylated polymers and copolymers, salts of hydroxy carboxylic acids, salts of condensation polymers of melamine urea and melamine formaldehyde, salts of condensation polymers of sulfonated naphthalene formaldehyde, formaldehyde/urea polymers, carboxylated polyethers, sulfonated condensation copolymers of formaldehyde and ketones, and combinations thereof.

63. The cementitious composition of claim 57 wherein the water-reducing component is selected from the group consisting of calcium or alkali salts of sulfonated lignin, hydroxylated polymers and copolymers, salts of hydroxy carboxylic acids, salts of condensation polymers of melamine urea and melamine formaldehyde, salts of condensation polymers of sulfonated naphthalene formaldehyde, formaldehyde/urea polymers, carboxylated polyethers, sulfonated condensation copolymers of formaldehyde and ketones, and combinations thereof.

64. The cementitious composition of claim 53 further comprising a fourth amount of a viscosity modifier effective to reduce segregation.

65. The cementitious composition of claim 54 further comprising a fourth amount of a viscosity modifier effective to reduce segregation.

66. The cementitious composition of claim 55 further comprising a fourth amount of a viscosity modifier effective to reduce segregation.

67. The cementitious composition of claim 56 further comprising a fourth amount of a viscosity modifier effective to reduce segregation.

68. The cementitious composition of claim 57 further comprising a fourth amount of a viscosity modifier effective to reduce segregation.

69. The cementitious composition of claim 58 further comprising a fourth amount of a viscosity modifier effective to reduce segregation.

70. The cementitious composition of claim 60 further comprising a fourth amount of a viscosity modifier effective to reduce segregation.

71. The cementitious composition of claim 64 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

72. The cementitious composition of claim 65 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

73. The cementitious composition of claim 66 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

74. The cementitious composition of claim 67 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

75. The cementitious composition of claim 68 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

76. The cementitious composition of claim 69 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

77. The cementitious composition of claim 70 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

78. A cementitious composition comprising:
from about 10% to about 95% by weight of a pozzolonic material comprising about 30% by weight or more amorphous silica,
from about 1% to about 85% by weight of a calcium-containing material, and
from about 0.1 to about 45% by weight of an alkali-containing zeolite.

79. The cementitious composition of claim 78 further comprising a water-reducing component effective to decrease by about 10% or more the amount of water that must be added to said cementitious composition to achieve a workable consistency.

80. The cementitious composition of claim 79 wherein the water-reducing component is selected from the group consisting of calcium or alkali salts of sulfonated lignin, hydroxylated polymers and copolymers, salts of hydroxy carboxylic acids, salts of condensation polymers of melamine urea and melamine formaldehyde, salts of condensation polymers of sulfonated naphthalene formaldehyde, formaldehyde/urea polymers, carboxylated polyethers, sulfonated condensation copolymers of formaldehyde and ketones, and combinations thereof.

81. The cementitious composition of claim 78 further comprising a viscosity modifier effective to reduce segregation.

82. The cementitious composition of claim 79 further comprising a viscosity modifier effective to reduce segregation.

83. The cementitious composition of claim 80 further comprising a viscosity modifier effective to reduce segregation.

84. The cementitious composition of claim 81 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

85. The cementitious composition of claim 82 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

86. The cementitious composition of claim 83 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

87. The cementitious composition of claim 1 wherein the strength of said cement product at 28 days is greater than the strength of the same cement product in the absence of said catalysts selected from the group consisting of zeolite, feldspathoid, and a combination thereof.

88. The cementitious composition of claim 2 wherein the strength of said cement product at 28 days is greater than the strength of the same cement product in the absence of said catalysts selected from the group consisting of zeolite, feldspathoid, and a combination thereof.

89. The cementitious composition of claim 40 wherein the strength of said cement product at 28 days is greater than the strength of the same cement product in the absence of said catalysts selected from the group consisting of zeolite, feldspathoid, and a combination thereof.

90. A cementitious composition comprising:
from about 10% to about 95% by weight of a pozzolonic material comprising about 30% by weight or more amorphous silica,
from about 1% to about 85% by weight of a calcium-containing material, and
from about 0.1 to about 45% by weight of an alkali-containing feldspathoid.

91. The cementitious composition of claim 90 further comprising a water-reducing component effective to decrease by about 10% or more the amount of water that must be added to said cementitious composition to achieve a workable consistency.

92. The cementitious composition of claim 91 wherein the water-reducing component is selected from the group consisting of calcium or alkali salts of sulfonated lignin, hydroxylated polymers and copolymers, salts of hydroxy carboxylic acids, salts of condensation polymers of melamine urea and melamine formaldehyde, salts of condensation polymers of sulfonated naphthalene formaldehyde, formaldehyde/urea polymers, carboxylated polyethers, sulfonated condensation copolymers of formaldehyde and ketones, and combinations thereof.

93. The cementitious composition of claim 90 further comprising a viscosity modifier effective to reduce segregation.

94. The cementitious composition of claim 91 further comprising a viscosity modifier effective to reduce segregation.

95. The cementitious composition of claim 92 further comprising a viscosity modifier effective to reduce segregation.

96. The cementitious composition of claim 93 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

97. The cementitious composition of claim 94 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

98. The cementitious composition of claim 95 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

99. A cementitious product comprising cementitious components and a catalyst selected from the group consisting of zeolite, feldspathoid, and a combination thereof.

100. The cementitious product of claim 99 further comprising a water-reducing component effective to decrease by about 10% or more the amount of water that must be added to said cementitious composition to achieve a workable consistency.

101. The cementitious product of claim 100 wherein the water-reducing component is selected from the group consisting of calcium or alkali salts of sulfonated lignin, hydroxylated polymers and copolymers, salts of hydroxy carboxylic acids, salts of condensation polymers of melamine urea and melamine formaldehyde, salts of condensation polymers of sulfonated naphthalene formaldehyde, formaldehyde/urea polymers, carboxylated polyethers, sulfonated condensation copolymers of formaldehyde and ketones, and combinations thereof.

102. The cementitious product of claim 99 further comprising a viscosity modifier effective to reduce segregation.

103. The cementitious product of claim 100 further comprising a viscosity modifier effective to reduce segregation.

104. The cementitious product of claim 101 further comprising a viscosity modifier effective to reduce segregation.

105. The cementitious product of claim 102 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

106. The cementitious product of claim 103 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

107. The cementitious product of claim 104 wherein the viscosity modifier is selected from the group consisting of hydroxyethyl cellulose, guar gum, carageenan gum, various clays, salts of acrylic acid and acrylic acid copolymers, acrylamide polymers and copolymers of acrylamide.

108. A method of making a cementitious composition comprising mixing a first quantity of pozzolonic material, a second quantity of alkaline earth metal, and an amount of catalyst selected from the group consisting of an alkali-containing zeolite, an alkali-containing feldspathoid, and combinations thereof, to produce the cementitious composition, the amount being effective to catalyze the pozzolonic reaction between a majority of the pozzolonic material and the alkaline earth metal.

109. The method of claim 108 wherein the pH of said pozzolonic reaction is from about 10 to about 14.

110. The method of claim 108 wherein the pH of said pozzolonic reaction is from about 11 to about 14.

111. The method of claim 108 wherein the pH of said pozzolonic reaction is about 12.

112. The method of claim 108 comprising adding an amount of water to the cementitious composition effective to achieve a workable consistency.

113. The method of claim 109 further comprising curing the cementitious composition to produce a cement product.

114. The method of claim 110 wherein the strength of the cement product at 28 days is greater than the strength of the same cement product in the absence of said catalysts selected from the group consisting of zeolite, feldspathoid, and a combination thereof.

115. A method of catalyzing a pozzolonic reaction comprising mixing a first quantity of pozzolonic material and a second quantity of alkaline earth metal with an amount of catalyst selected from the group consisting of an alkali-containing zeolite, an alkali-containing feldspathoid, and combinations thereof, the amount being effective to catalyze the pozzolonic reaction between a majority of the pozzolonic material and the alkaline earth metal.

116. The method of claim 115 wherein the amount of the catalyst is effective to catalyze the pozzolonic reaction between substantially all of the pozzolonic material and the alkaline earth metal.

117. The method of claim 115 further comprising adding an amount of a water-reducing component to the cementitious composition in an amount effective to decrease by about 10% or more the amount of water that must be added to said cementitious composition to achieve a workable consistency.

118. The method of claim 116 further comprising adding an amount of a water-reducing component to the cementitious composition in an amount effective to decrease by about 10% or more the amount of water that must be added to said cementitious composition to achieve a workable consistency.

119. The method of claim 115 further comprising adding an amount of a viscosity modifier to the cementitious composition effective to reduce segregation.

120. The method of claim 116 further comprising adding an amount of a viscosity modifier to the cementitious composition effective to reduce segregation.

121. The method of claim 117 further comprising adding an amount of a viscosity modifier to the cementitious composition effective to reduce segregation.

122. The method of claim 118 further comprising adding an amount of a viscosity modifier to the cementitious composition effective to reduce segregation.
